(19) United States
(12) Patent Application Publication
(10) Pub. No.: US 2013/0151809 A1
(43) Pub. Date: Jun. 13, 2013

(54) ARITHMETIC PROCESSING DEVICE AND METHOD OF CONTROLLING ARITHMETIC PROCESSING DEVICE

(71) Applicant: FUJITSU LIMITED, Kawasaki-shi (JP)

(72) Inventor: Masaharu MARUYAMA, Kawasaki (JP)

(73) Assignee: FUJITSU LIMITED, Kawasaki-shi (JP)

(21) Appl. No.: 13/710,593

(22) Filed: Dec. 11, 2012

(30) Foreign Application Priority Data
Dec. 13, 2011 (JP) 2011-272807

(51) Int. Cl. G06F 12/10

(52) U.S. Cl. CPC G06F 12/1036
USPC 711/205

(57) ABSTRACT

An arithmetic processing device includes: an processing unit configured to execute threads and output a memory request including a virtual address; a buffer configured to register some of address translation pairs stored in a memory, each of the address translation pairs including a virtual address and a physical address; a controller configured to issue requests for obtaining the corresponding address translation pairs to the memory for individual threads when an address translation pair corresponding to the virtual address included in the memory request output from the processing unit is not registered in the buffer; table fetch units configured to obtain the corresponding address translation pairs from the memory for individual threads when the requests for obtaining the corresponding address translation pairs are issued; and a registration controller configured to register one of the obtained address translation pairs in the buffer.

### CROSS-REFERENCE TO RELATED APPLICATION

This application is based upon and claims the benefit of priority of the prior Japanese Patent Application No. 2011-272807, filed on Dec. 13, 2011, the entire contents of which are incorporated herein by reference.

### FIELD

The embodiments discussed herein are related to an arithmetic processing device and a method for controlling the arithmetic processing device.

### BACKGROUND

In general, a technique of providing a virtual memory space which is larger than a physical memory space is used as a virtual storage system. An information processing apparatus employing such a virtual storage system stores a TTE (Translation Table Entry) which includes a pair of a virtual address referred to as a “TTE-Tag” and a physical address referred to as “TTE-Data” in a main memory. When performing address translation between the virtual address and the physical address, the information processing apparatus accesses the main memory and executes the address translation with reference to the TTE stored in the main memory.

Here, if the information processing apparatus accesses the main memory every time the address translation is performed, a period of time used for execution of the address translation is increased. Therefore, a technique of installing, in an arithmetic processing device, a translation lookaside buffer (TLB) which is a cache memory used to register TTEs is generally used.

Hereinafter, an example of the arithmetic processing device including such a TLB will be described. FIG. 9 is a flowchart illustrating a process executed by an arithmetic processing device including a Translation Lookaside Buffer (TLB). Note that the process illustrated in FIG. 9 is an example of a process executed by the arithmetic processing device when a memory access request using a virtual address is issued. For example, in the example illustrated in FIG. 9, the arithmetic processing device waits until a memory access request is issued (step S1; No).

When the memory access request has been issued (step S1; Yes), the arithmetic processing device searches the TLB for a TTE including a TTE-Tag corresponding to a virtual address of a storage region which is a target of memory access (in step S2). When the TTE of the searching target has been stored in the TLB (step S3; Yes), the arithmetic processing device obtains a physical address from the TTE of the searching target and performs the memory access to a cache memory using the obtained physical address (in step S4).

On the other hand, when the virtual address which is the searching target has not been stored in the TLB (step S3; No), the arithmetic processing device cancels subsequent processes to be performed in response to the memory access request and causes an OS (Operating System) to execute a trap process described below. Specifically, the OS reads the virtual address which is the target of the memory access from a register (in step S5).

Then, the OS reads a TSB (Translation Storage Buffer) pointer calculated from the read virtual address from the register (in step S6). Here, the TSB pointer represents a physical address of a storage region which stores a TTE including a TTE-Tag corresponding to the virtual address read in step S5.

Furthermore, the OS obtains a TTE from a region specified by the read TSB pointer (in step S7) and registers the obtained TTE in the TLB (in step S8). Thereafter, the arithmetic processing device performs translation between the virtual address and the physical address with reference to the TTE stored in the TLB.

Here, hardware virtualization techniques such as cloud computers have been generally used, and in an information processing apparatus employing such a hardware virtualization technique, a hypervisor executes a plurality of OSs and memory management. Therefore, when an information processing apparatus which employs such a virtualization technique performs an address translation process, the hypervisor operates in addition to the OSs, and accordingly, overhead in the address translation process is increased. Furthermore, in the information processing apparatus employing the virtualization technique, when trap processes are performed in the plurality of OSs, load of the hypervisor is increased resulting in increase of penalties of the trap processes.

To address this problem, an HWTW (Hard Ware Table Walk) technique of executing a process of obtaining a TTE and a process of registering the TTE using hardware instead of an OS or a hypervisor has been generally used. Hereinafter, an example of a process executed by an arithmetic processing device including an HWTW will be described with reference to the drawings.

FIG. 10 is a flowchart illustrating a process executed by a general arithmetic processing device. Note that, among operations illustrated in FIG. 10, operations in step S11 to step S13, an operation in step S25, and operations in step S21 to step S24 are the same as the operations in step S1 to step S3, the operation in step S4, and the operations in step S5 to S8, respectively, and therefore, detailed descriptions thereof are omitted.

In the example illustrated in FIG. 10, when a TTE including a TTE-Tag corresponding to a virtual address serving as the target of memory access has not been stored in a TLB (step S13; No), the arithmetic processing device determines whether registration of a TTE corresponding to a preceding memory access request is completed (in step S14). When the registration of the TTE corresponding to the preceding memory access request has not been completed (step S14; No), the arithmetic processing device waits until the registration of the TTE corresponding to the preceding memory access request is completed.

On the other hand, when the registration of the TTE corresponding to the processing memory access request has been completed (in step S14; Yes), the arithmetic processing device determines whether an HWTW execution setting is valid (in step S15). When determining that the HWTW execution setting is valid (step S15; Yes), the arithmetic processing device activates the HWTW (in step S16). When the arithmetic processing device determines that the HWTW execution setting is valid, the HWTW reads a TSB pointer (in step S17) so as to access a main memory using the TSB pointer, and registers an obtained TTE in the TLB (in step S18).

Thereafter, the HWTW determines whether the obtained TTE is appropriate (in step S19). When the obtained TTE is appropriate (step S19; Yes), the obtained TTE is stored in the TLB (in step S20). When the obtained TTE is inappropriate (step S19; No), the HWTW causes the OS to execute a trap process (in step S21 to step S24).

### SUMMARY

According to an aspect of the invention, an arithmetic processing device includes an arithmetic processing unit configured to execute a plurality of threads and output a memory request including a virtual address; a buffer configured to register some of a plurality of address translation pairs stored in a memory, each of the address translation pairs including a virtual address and a physical address; a controller configured to issue requests for obtaining the corresponding address translation pairs to the memory for individual threads when an address translation pair corresponding to the virtual address included in the memory request output from the arithmetic processing unit is not registered in the buffer; a plurality of table fetch units configured to obtain the corresponding address translation pairs from the memory for individual threads when the requests for obtaining the corresponding address translation pairs are issued; and a registration controller configured to register one of the obtained address translation pairs in the buffer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an arithmetic processing device according to an embodiment;

FIG. 2 is a diagram illustrating a Translation Lookaside Buffer according to the embodiment;

FIG. 3 is a diagram illustrating a Hard Ware Table Walk according to the embodiment;

FIG. 4 is a diagram illustrating table walk according to an embodiment;

FIG. 5A is a diagram illustrating a process of consecutively performing trap processes by an OS;

FIG. 5B is a diagram illustrating a process performed by a Hard Ware Table Walk of a comparative example;

FIG. 5C is a diagram illustrating a process performed by the Hard Ware Table Walk according to the embodiment;

FIG. 6 is a flowchart illustrating a process performed by a CPU according to the embodiment;

FIG. 7 is a flowchart illustrating the process performed by the Hard Ware Table Walk according to the embodiment;

FIG. 8 is a flowchart illustrating a process performed by a TSBW controller according to the embodiment;

FIG. 9 is a flowchart illustrating a process executed by an arithmetic processing device including a Translation Lookaside Buffer; and

FIG. 10 is a diagram illustrating a process executed by a general arithmetic processing device.

### DESCRIPTION OF EMBODIMENTS

In the related arts in which a process of obtaining a TTE and a process of registering the TTE are successively executed by an HWTW, a TTE is searched for in response to a memory access request after registration of a TTE corresponding to a preceding memory access request is completed. Therefore, when memory access requests corresponding to TTEs which have not been registered in a TLB are consecutively issued, a period of time used for execution of address translation is increased.

According to this embodiment, the period of time used for execution of address translation is reduced.

An arithmetic processing device and a method for controlling the arithmetic processing device according to this embodiment will be described hereinafter with reference to the accompanying drawings.

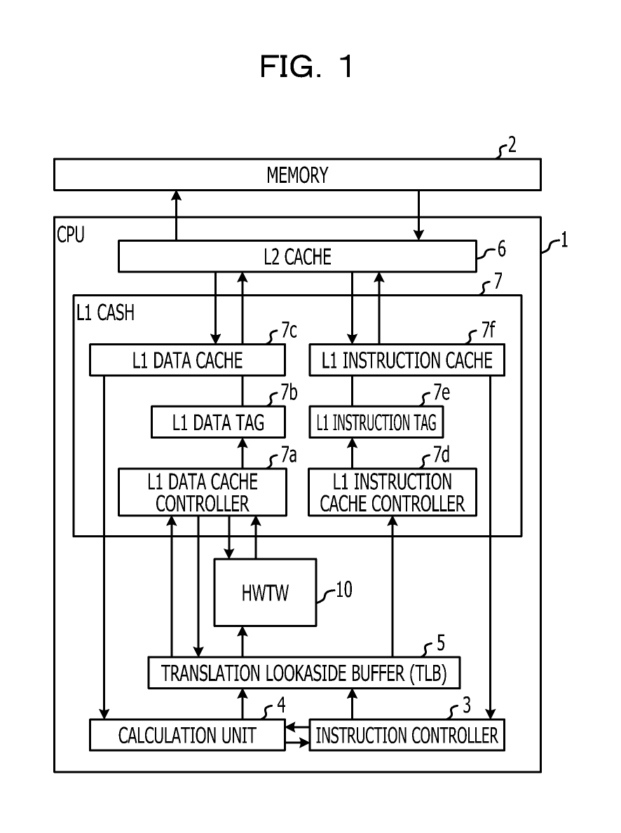

In the embodiment below, an example of the arithmetic processing device will be described with reference to FIG. 1. FIG. 1 is a diagram illustrating the arithmetic processing device according to the embodiment. Note that, in FIG. 1, a CPU (Central Processing Unit) 1 is illustrated as an example of the arithmetic processing device.

In the example of FIG. 1, the CPU 1 is connected to a memory 2 serving as a main memory. Furthermore, the CPU 1 includes an instruction controller 3, a calculation unit 4, a translation lookaside buffer (TLB) 5, an L2 (Level 2) cache 6, an L1 (Level 1) cache 7. The CPU 1 further includes an HWTW (Hard Ware Table Walk) 10. Moreover, the L1 cache 7 includes an L1 data cache controller 7a, an L1 data tag 7b, an L1 data cache 7c, an L1 instruction cache controller 7d, an L1 instruction tag 7e, and an L1 instruction cache 7f.

The memory 2 stores data to be used in arithmetic processing by the CPU 1. For example, the memory 2 stores data representing values to be subjected to the arithmetic processing performed by the CPU 1, that is, operands, and data representing instructions regarding the arithmetic processing. Here, the term “instruction” represents an instruction executable by the CPU 1.

Furthermore, the memory 2 stores TTEs (Translation Table Entries) including pairs of virtual addresses and physical addresses in a predetermined region. Here, a TTE has a pair of a TTE-Tag and TTE-Data, and the TTE-Tag stores a virtual address and the TTE-Data stores a physical address.

The instruction controller 3 controls a flow of a process executed by the CPU 1. Specifically, the instruction controller 3 reads an instruction to be processed by the CPU 1 from the L1 cache 7, interprets the instruction, and transmits a result of the interpretation to the calculation unit 4. Note that the instruction controller 3 obtains instructions regarding the arithmetic processing from the L1 instruction cache 7f included in the L1 cache 7 whereas the calculation unit 4 obtains instructions and operands regarding the arithmetic processing from the L1 data cache 7c included in the L1 cache 7.

The calculation unit 4 performs calculations. Specifically, the calculation unit 4 reads data serving as a target of an instruction, that is, an operand, from a storage device, performs calculation in accordance with an instruction interpreted by the instruction controller 3, and transmits a result of the calculation to the instruction controller 3.

Here, when obtaining an operand or an instruction, the instruction controller 3 or the calculation unit 4 outputs a virtual address of the memory 2 which stores the operand or the instruction to the TLB 5. Furthermore, the instruction controller 3 or the calculation unit 4 outputs unique context IDs for individual pairs of strands (threads) which are units of the arithmetic processing executed by the CPU 1 and virtual addresses to the TLB 5.

As described hereinafter, when the instruction controller 3 or the calculation unit 4 outputs a virtual address, the TLB 5 translates the virtual address into a physical address using a TTE and outputs the physical address obtained after the translation to the L1 cache 7. In this case, the L1 cache 7 outputs an instruction or an operand to the instruction controller 3 or the calculation unit 4 using the physical address output from the TLB 5. Thereafter, the instruction controller 3 or the calculation unit 4 executes various processes using operands or instructions received from the L1 cache 7.

Some of TTEs stored in the memory 2 are registered in the TLB 5. The TLB 5 is an address translation buffer which translates a virtual address output from the instruction controller 3 or the calculation unit 4 into a physical address using a TTE and outputs the physical address obtained after the translation to the L1 cache 7. Specifically, pairs of some of the TTEs stored in the memory 2 and context IDs are registered in the TLB 5.

When the instruction controller 3 or the calculation unit 4 outputs a virtual address and a context ID, the TLB 5 executes the following process. Specifically, the TLB 5 determines whether a pair of an TTE including a TTE-Tag corresponding to the virtual address output from the instruction controller 3 or the calculation unit 4 and a context ID corresponding to the TTE has been registered by checking the pairs of TTEs and context IDs registered therein.

When the pair of the TTE including the TTE-Tag corresponding to the virtual address output from the instruction controller 3 or the calculation unit 4 and the context ID corresponding to the TTE has been registered, the TLB 5 determines that a “TLB hit” is obtained. Thereafter, the TLB 5 outputs TTE-Data of the TTE corresponding to the TLB hit to the L1 cache 7.

On the other hand, when the pair of the TTE including the TTE-Tag corresponding to the virtual address output from the instruction controller 3 or the calculation unit 4 and the context ID corresponding to the TTE has not been cached, the TLB 5 determines that a “TLB miss” is obtained. Note that the TLB miss may be represented by “MMU (Memory Management Unit)-MISS”.

In this case, the TLB 5 issues a memory access request using the TTE including the TTE-Tag corresponding to the virtual address of the TLB miss to the HWTW 10. Note that the memory access request using the TTE includes the virtual address, the context ID of the TTE, and a strand ID which uniquely represents a unit of processing of the calculation process corresponding to the issuance of the memory access request, that is, a strand (thread).

Furthermore, as described hereinafter, the HWTW 10 includes a plurality of reception units which receive memory access requests, and the TLB 5 issues different memory access requests to the different reception units in different strands (threads) regarding TLB misses. In this case, the HWTW 10 registers a TTE serving as a target of a memory access request issued by the TLB 5 in the TLB 5 through the L2cache 6 and the L1 cache 7. Thereafter, the TLB 5 outputs TTE-Data of the registered TTE to the L1 cache 7.

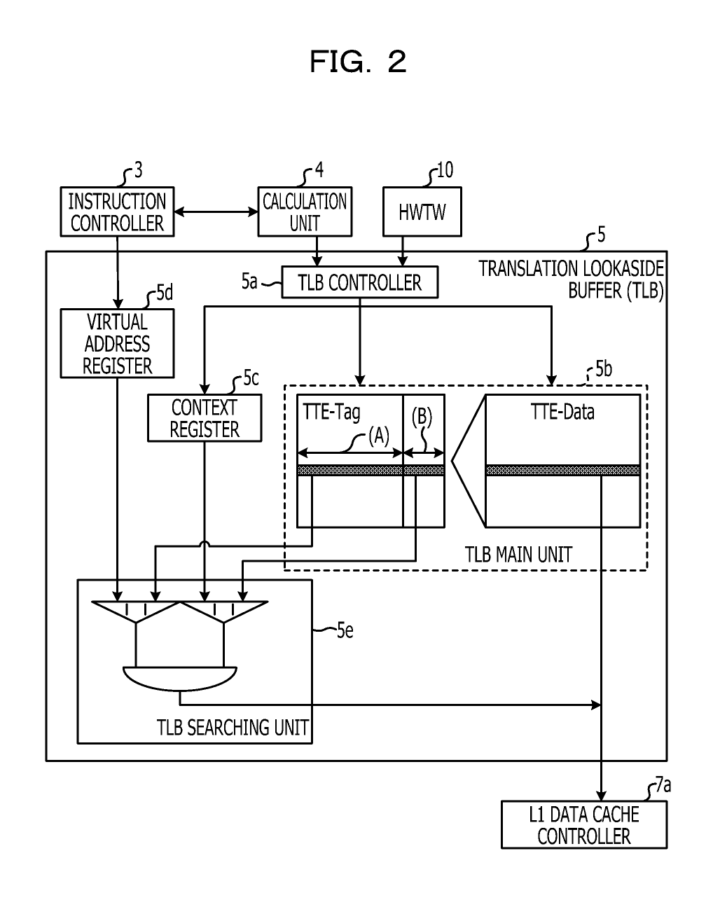

FIG. 2 is a diagram illustrating the Translation Lookaside Buffer according to the embodiment. In the example of FIG. 2, the TLB 5 includes a TLB controller 5a, a TLB main unit 5b, a context register 5c, a virtual address register 5d, and a TLB searching unit 5e. The TLB controller 5a controls a process of obtaining a TTE from the calculation unit 4 or the HWTW 10 and registering the TTE. For example, the TLB controller 5a newly obtains a TTE in accordance with a program executed by the CPU 1 from the calculation unit 4 and registers the obtained TTE to the TLB main unit 5b.

Here, the TLB main unit 5b stores TTE-Tags and TTE-Data of TTEs which are associated with each other. Furthermore, each of the TTE-Tags includes a virtual address in a range denoted by (A) illustrated in FIG. 2 and a context ID in a range denoted by (B) illustrated in FIG. 2. The context register 5c stores a context ID of a TTE of a searching target, and the virtual address register 5d stores a virtual address included in a TTE-Tag of the TTE of the searching target.

The TLB searching unit 5e searches the TLB main unit 5b which stores the TTEs for a TTE having a virtual address included in a TTE-Tag which corresponds to a virtual address stored in the virtual address register 5d. Simultaneously, the TLB searching unit 5e searches for a TTE having a context ID included in a TTE-Tag which corresponds to the context ID stored in the context register 5c. Then, the TLB searching unit 5e outputs TTE-Data of the TTE corresponding to the virtual address and the context ID, that is, a virtual address of a searching target and a corresponding physical address to the L1 data cache controller 7a.

Referring back to FIG. 1, when the TLB 5 outputs a physical address to obtain an operand, the L1 data cache controller 7a performs the following process. Specifically, the L1 data cache controller 7a searches a cache line corresponding to a lower address of the physical address for tag data corresponding to a frame address (higher address) of the physical address in the L1 data tag 7b. When tag data corresponding to the physical address output from the TLB 5 has been detected, the L1 data cache controller 7a causes the L1 data cache 7c to output data such as an operand cached after being associated with the detected tag data. On the other hand, when the tag data corresponding to the physical address output from the TLB 5 has not been detected, the L1 data cache controller 7a causes the L1 data cache 7c to store data such as an operand stored in the L2 cache 6 or the memory 2.

Furthermore, when the HWTW 10 described below outputs a TRF request which is a request for caching a TTE, the L1 data cache controller 7a stores a TTE stored in an address which is a target of the TRF request in the L1 data cache 7c. Specifically, the L1 data cache controller 7a causes the L1 data cache 7c to store a TTE stored in the L2 cache 6 or the memory 2 as a case where the L1 data cache controller 7a causes the L1 data cache 7c to store an operand. Then, the L1 data cache controller 7a causes the HWTW 10 to output a TRF request again and registers the TTE stored in the L1 data cache 7c in the TLB 5.

When the TLB 5 outputs a physical address for obtaining an instruction, the L1 instruction cache controller 7d performs a process the same as that performed by the L1 data cache controller 7a so as to output an instruction stored in the L1 instruction cache 7f to the instruction controller 3.

Furthermore, when the L1 instruction cache 7f does not store an instruction, the L1 instruction cache controller 7d causes the L1 instruction cache 7f to store an instruction stored in the memory 2 or an instruction stored in the L2 cache 6. Thereafter, the L1 instruction cache controller 7d outputs the instruction stored in the L1 instruction cache 7f to the instruction controller 3. Note that, since the L1 instruction tag 7e and the L1 instruction cache 7f have functions similar to those of the L1 data tag 7b and the L1 data cache 7c, respectively, and detailed descriptions thereof are omitted.

Note that, when an operand, an instruction, or data such as a TTE has not been stored in the L1 data cache 7c or the L1 instruction cache 7f, the L1cache 7 outputs a physical address to the L2 cache 6. In this case, the L2 cache 6 determines whether the L2 cache 6 itself stores data to be stored in the physical address output from the L1 cache 7. When the L2 cache 6 itself stores the data, the L2 cache 6 outputs the data to the L1 cache 7. On the other hand, when the L2 cache 6 itself does not store the data to be stored in the physical address output from the L1 cache 7, the L2 cache 6 performs the following process. Specifically, the L2 cache 6 caches, from the memory 2, the data stored in the physical address output from the L1 cache 7 and outputs the cached data to the L1 cache 7.

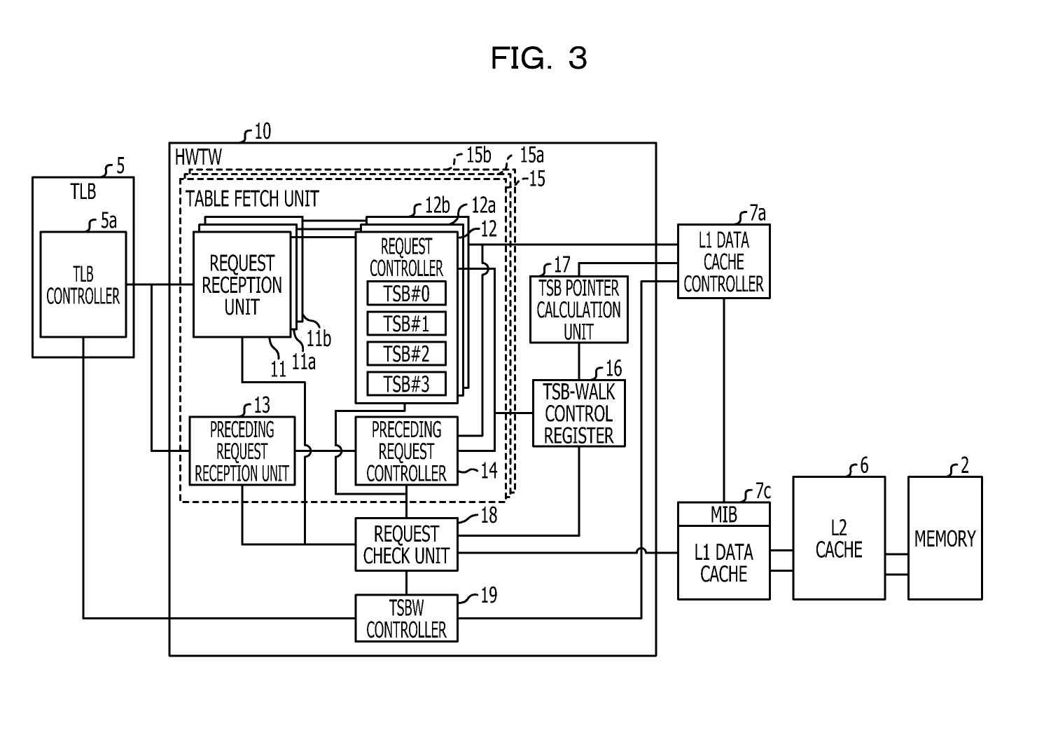

Next, the Hard Ware Table Walk (HWTW) 10 will be described with reference to FIG. 3. FIG. 3 is a diagram illustrating the HWTW 10 according to the embodiment. In the example illustrated in FIG. 3, the HWTW 10 includes a plurality of table fetch units 15, 15a, and 15b, a TSB-Walk control register 16, a TSB (Translation Storage Buffer) pointer calculation unit 17, a request check unit 18, and a TSBW (TSB Write) controller 19.

Note that, although a case where the HWTW 10 includes the three table fetch units 15, 15a, and 15b is described herein as an example, the number of table fetch units is not limited to this. Note that the table fetch units 15a and 15b have functions the same as that of the table fetch unit 15 in the description below, and therefore, detailed descriptions thereof are omitted.

The table fetch unit 15 includes a plurality of request reception units 11, 11a, and 11b, a plurality of request controllers 12, 12a, and 12b, a preceding request reception unit 13, and a preceding request controller 14. Furthermore, the TLB 5 includes the TLB controller 5a. When a TLB miss occurs, the TLB controller 5a issues different requests to the different table fetch units 15, 15a, and 15b for individual strands (threads) regarding the TLB miss.

For example, when the CPU 1 executes three strands A to C, the TLB controller 5a issues requests as follows. Specifically, the TLB controller 5a issues a request of the strand A to the table fetch unit 15, a request of the strand B to the table fetch unit 15a, and a request of the strand C to the table fetch unit 15b.

Note that the TLB controller 5a does not issue requests of specific strands (threads) to the table fetch units 15, 15a, and 15b, but a destination of an issuance of a request is changed depending on a strand (thread) being executed. For example, when the strands A to C are executed and the strand (thread) B is terminated, and thereafter, another strand D is added so that strands A, C, and D are executed, the TLB controller 5a may issue a request of the strand D to a table fetch unit to which a request of the strand B has been issued.

Furthermore, when a request corresponding to a TTE including a virtual address of a storage region storing an operand to be translated into a physical address is first issued, that is, when an issued request corresponds to a TOQ (Top Of Queue) stored in a leading queue of a request queue, the TLB controller 5a performs the following process. Specifically, the TLB controller 5a issues the first request to the preceding request reception unit 13 included in a table fetch unit which is a destination of request issuance.

For example, when intending to issue a request of the TOQ of the strand A to the table fetch unit 15, the TLB controller 5a issues the request to the preceding request reception unit 13. Furthermore, while the strand A is executed, when a request to be issued is a request regarding a TTE regarding an instruction or when a succeeding request of a TTE regarding an operand is to be issued, the TLB controller 5a issues the request to one of the request reception units 11, 11a, and 11b.

One of the request reception units 11, 11a, and 11b obtains and stores the request issued by the TLB controller 5a. Furthermore, one of the request reception units 11, 11a, and 11b causes a corresponding one of the request controllers 12, 12a, and 12b to obtain the TTE which is a target of the request.

One of the request controllers 12, 12a, and 12b obtains the request from a corresponding one of the request reception units 11, 11a, and 11b and independently executes a process of obtaining the TTE which is a target of the obtained request. Specifically, each of the request controllers 12, 12a, and 12b includes a plurality of TSBs (Translation Storage Buffers) #0 to #3 which are table walkers and causes the TSBs #0 to #3 to execute a TTE obtainment process.

The preceding request reception unit 13 receives a first request regarding a TTE having a virtual address of a storage region storing an operand to be translated into a physical address. Furthermore, the preceding request controller 14 has a function similar to those of the request controllers 12, 12a, and 12b and obtains the TTE which is the target of the request received by the preceding request reception unit 13. Specifically, the preceding request reception unit 13 and the preceding request controller 14 obtain the TTE which is the target of the request of the TOQ.

As described above, the TLB controller 5a issues a request for obtaining a TTE of the same strand (thread) to the request reception units 11, 11a, and 11b and the request controllers 12, 12a, and 12b included in the same the table fetch unit 15. Therefore, the HWTW 10 including the table fetch units 15, 15a, and 15b may perform processes of obtaining TTEs regarding different operands of different strands (threads) in parallel.

Furthermore, since the table fetch unit 15 includes the plurality of request reception units 11, 11a, and 11b, the plurality of request controllers 12, 12a, and 12b, the preceding request reception unit 13, and the preceding request controller 14, a TOQ request and other requests can be simultaneously processed in parallel. Furthermore, since the table fetch unit 15 can simultaneously process the TOQ request and the other requests in parallel, a penalty in which a process of a request is suspended until a process of a preceding TOQ request is completed can be avoided. Furthermore, since the HWTW 10 includes the plurality of table fetch units 15, 15a, and 15b, the HWTW 10 can perform different processes of obtaining TTEs regarding obtainment of operands for individual strands (threads) in parallel.

The TSB-Walk control register 16 includes a plurality of TSB configuration registers. Each of the TSB configuration registers stores a value used to calculate a TSB pointer. The TSB pointer calculation unit 17 calculates a TSB pointer using the values stored in the TSB configuration registers. Thereafter, the TSB pointer calculation unit 17 outputs the obtained TSB pointer to the L1 data cache controller 7a.

The request check unit 18 checks whether a TTE supplied from the L1 data cache 7c is the TTE of the request target and supplies a result of the checking to the TSBW controller 19. When the result of the checking performed by the request check unit 18 represents positive, that is, when the TTE supplied from the L1 data cache 7c is the TTE of the request target, the TSBW controller 19 issues a registration request to the TLB controller 5a. As a result, the TLB controller 5a registers the TTE stored in the L1 data cache 7c.

On the other hand, when detecting a trap factor which causes generation of a trap, the request check unit 18 notifies the TSBW controller 19 of the detected trap factor.

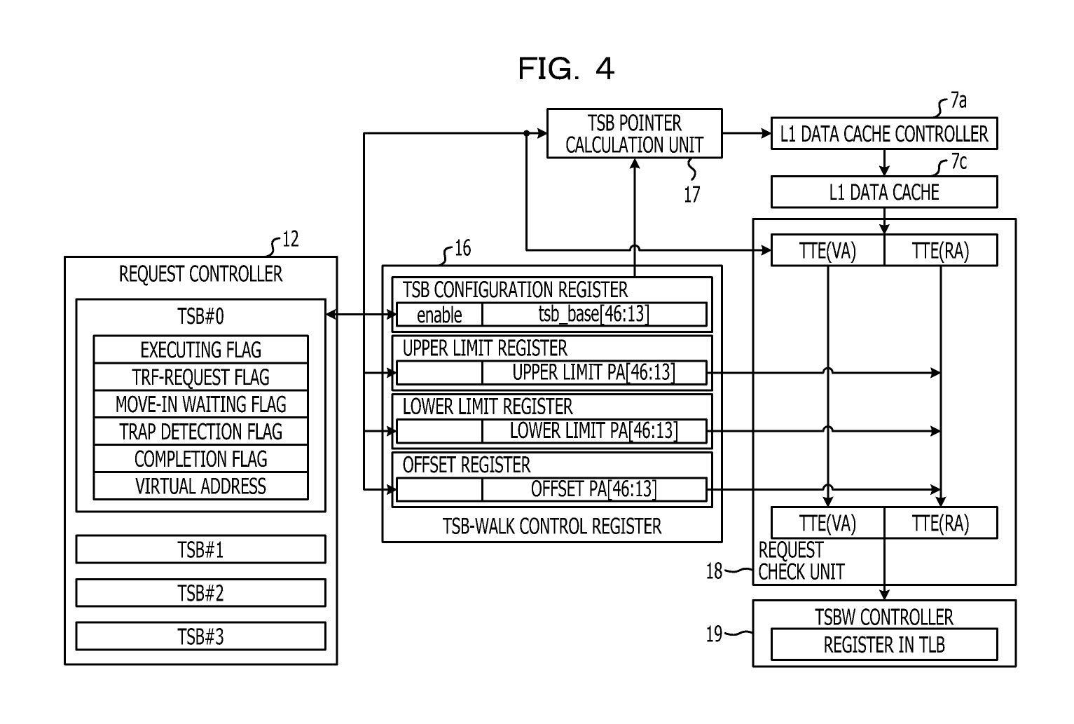

Hereinafter, table walk executed by the request controller 12 will be described with reference to FIG. 4. FIG. 4 is a diagram illustrating the table walk according to the embodiment. Note that the request controllers 12a and 12b perform processes the same as that performed by the request controller 12, and therefore, descriptions thereof are omitted. Furthermore, the TSBs #1 to #3 perform processes the same as that performed by the TSB #0, and therefore, descriptions thereof are omitted.

For example, in the example illustrated in FIG. 4, the TSB #0 includes data such as an executing flag, a TRF-request flag, a move-in waiting flag, a trap detection flag, a completion flag, and a virtual address included in the TTE of the request target. Here, the executing flag is flag information representing whether the TSB #0 is executing table walk. The TSB #0 turns the executing flag on when the table walk is being executed.

Furthermore, the TRF-request flag is flag information representing whether a TRF request for obtaining data stored in a storage region specified by the TSB pointer calculated by the TSB pointer calculation unit 17 has been issued to the L1 data cache controller 7a. Specifically, the TSB #0 turns the TRF-request flag on when the TRF request is issued.

Furthermore, the move-in waiting flag is flag information representing whether a move-in process of moving data stored in the memory 2 or the L2 cache 6 to the L1 data cache 7c is being executed. The TSB #0 turns the move-in waiting flag on when the L1 data cache 7c is performing the move-in process. The trap detection flag represents whether a trap factor has been detected. The TSB #0 turns the trap detection flag on when the trap factor is detected. The completion flag represents whether the table walk has been completed. The TSB #0 turns the completion flag on when the table walk is completed whereas the TSB #0 turns the completion flag off when another table walk is to be performed.

Furthermore, in the example illustrated in FIG. 4, the TTE includes a TTE-Tag section of eight bytes and a TTE-Data section of eight bytes. A virtual address is stored in the TTE-Tag section whereas an RA (Real Address) is stored in the TTE-Data section. Furthermore, in the example illustrated in FIG. 4, the TSB-Walk control register 16 includes the TSB configuration registers, an upper-limit register, a lower-limit register, and an offset register. Note that the RA is used to calculate a physical address (PA).

The TSB configuration registers store data used by the TSBs #0 to #3 to calculate TSB pointers. Furthermore, the upper limit register and the lower limit register store data representing a range of a physical address to which a TTE is stored. Specifically, an upper limit value of a physical address (upper limit PA [46:13]) is stored in the upper limit register whereas a lower limit value of the physical address (lower limit PA [46:13]) is stored in the lower limit register. Furthermore, the offset register is used as a combination with the upper and lower registers and stores an offset PA [46:13] used to calculate a physical address to be registered in the TLB from the RA.

For example, the TSB #0 refers to a request stored in the request reception unit 11. Then the TSB #0 selects one of the TSB configuration registers, the upper limit register, the lower limit register, and the offset register included in the TSB-Walk control register 16 using a context ID and a strand ID of a TTE of a request target. Thereafter, the TSB #0 refers to a table walk significant bit representing whether table walk is to be executed in the TSB configuration register. In the example of FIG. 4, the table walk significant bit is in an enable range.

When the table walk significant bit representing whether the table walk is to be executed is in an on state, the TSB #0 starts the table walk. Then the TSB #0 causes the selected TSB configuration register to output a base address (tsb_base[46:13]) set in the selected TSB configuration register to the TSB pointer calculation unit 17. Furthermore, although omitted in FIG. 4, the TSB configuration register includes a size of the TSB and a page size, and the TSB #0 causes the TSB configuration register to output the size of the TSB and the page size to the TSB pointer calculation unit 17.

The TSB pointer calculation unit 17 calculates a TSB pointer which is a physical address representing a storage region which stores a TTE using the base address, the size of the TSB, and the page size which are output from the TSB-Walk control register 16. Specifically, the TSB pointer calculation unit 17 calculates a TSB pointer by assigning the base address, the size of the TSB, and the page size which are output from the TSB-Walk control register 16 to Expression (1) below.

Note that “pa” included in Expression (1) denotes the TSB pointer, “VA” denotes a virtual address, “tsb_size” denotes the TSB size, and “page_size” denotes the page size. Specifically, Expression (1) represents that “tsb_base” is in a position moved from the “46”-th bit of the physical address by “13+tsb_size” bits. Furthermore, Expression (1) represents that the VA is in a position moved from the “21+tsb_size+(3*page_size)”-th bit by “13+(3*page_size)” bits and the other bits are set to “0”.

pa:=tsb_base[46:13+tsb_size]::VA[21+tsb_size+(3*page_size): (13+(3*page_size))]::0000 (1)

When the TSB pointer calculation unit 17 calculates the TSB pointer, the TSB #0 issues a TRF request to the L1 data cache controller 7a and turns the TRF-request flag on. Specifically, the TSB #0 causes the TSB pointer calculation unit 17 to output the TSB pointer calculated by the TSB pointer calculation unit 17 to the L1 data cache controller 7a. Meanwhile, the TSB #0 transmits a request port ID (TRF-REQ-SRC-ID) uniquely representing the request reception unit 11 which has received a TTE request and a table walker ID (TSB-PORT-ID) representing the TSB #0 to the L1 data cache controller 7a.

Note that the TSB-Walk control register 16 includes the plurality of TSB configuration registers, and different TSB page addresses, different TSB sizes, and different page sizes are set to the different TSB configuration registers by the OS (Operating System). Then, the different TSBs #0 to #3 included in the request controller 12 select the different TSB configuration registers from the TSB-Walk control register 16. Therefore, since the different TSBs #0 to #3 cause the TSB pointer calculation unit 17 to calculate TSB pointers of different values, different TRF requests for different TSB pointers are issued from the same virtual address.

For example, the memory 2 includes four regions which store TTEs and determines one of the regions to which a TTE is to be stored when the OS is activated. Therefore, when the request controller 12 includes only one TSB #0, a TRF request is issued to all the four candidates and a period of time used for the table walk is increased. However, when the request controller 12 includes four TSBs #0 to #3 which issue TRF requests to the regions, the request controller 12 causes the TSBs #0 to #3 to issue the TRF requests to the regions so as to promptly obtain a TTE.

Note that an arbitrary number of regions which store TTEs may be set to the memory 2. Specifically, when the memory 2 includes six regions which store TTEs, six TSBs #0 to #5 may be included in the request controller 12 so as to issue TRF requests to the regions.

Referring back to FIG. 4, when obtaining a TRF request issued by the TSB #0, the L1 data cache controller 7a determines whether a TTE which is a target of the obtained TRF request has been stored in the L1 data cache 7c. When the TTE which is the target of the TRF request has been stored in the L1 data cache 7c, that is, when a cache hit is attained, the L1 data cache controller 7a notifies the TSB #0 which has issued the TRF request of a fact that the cache hit is attained.

On the other hand, when the TTE which is the target of the TRF request has not been stored in the L1 data cache 7c, that is, when a cache miss occurs, the L1 data cache controller 7a causes the L1 data cache 7c to store the TTE. Then, the L1 data cache controller 7a determines whether the TTE of the target of the TRF request has been stored in the L1 data cache 7c again.

Hereinafter, a case where a TRF request issued by the TSB #0 is obtained by the L1 data cache controller 7a will be described as an example. For example, the L1 data cache controller 7a which has obtained a TRF request determines that the TRF request is issued by the TSB #0 included in the request controller 12 in accordance with the request port ID and the table walker ID.

After obtaining a priority of issuance of a request, the L1 data cache controller 7a issues the TRF request to an L1 cache control pipe line. Specifically, the L1 data cache controller 7a determines whether the TTE which is the target of the TRF request, that is, the TTE stored in a storage region represented by the TSB pointer, has been stored.

When the TRF request attains a cache hit, the L1 data cache controller 7a outputs a signal representing that data of a target of the TRF request has been stored at a timing when the request has been supplied through the L1 cache control pipe line. In this case, the TSB #0 causes the L1 data cache 7c to transmit the stored data and determine whether the transmitted data corresponds to the TTE requested by the TLB controller 5a using the request check unit 18.

On the other hand, when the TTE has not been stored, that is, the TTE which is the target of the TRF request corresponds to a cache miss, the following process is performed. First, the L1 data cache controller 7a causes an MIB (Move In Buffer) of the L1 data cache 7c illustrated in FIG. 3 to store a flag representing a TRF request.

Then the L1 data cache controller 7a causes the L1 data cache 7c to issue a request for performing a move-in process of data stored in the storage region which is the target of the TRF request to the L2 cache 6. Furthermore, the L1 data cache controller 7a outputs, to the TSB #0, a signal representing that the MIB is ensured due to L1 cache miss at the timing when the TRF request has been supplied through the L1 cache control pipe line. In this case, the TSB #0 turns the move-in waiting flag on.

Here, when the request for performing the move-in process is issued, the L2 cache 6 stores the data which is the target of the TRF request supplied from the memory 2 by performing an operation the same as that performed in response to a normal loading instruction and transmits the stored data to the L1 data cache 7c. In this case, the MIB causes the L1 data cache 7c to store the data transmitted from the L2 cache 6 and determines that the data stored in the L1 data cache 7c is the target of the TRF request. Then the MIB issues an instruction for issuing the TRF request again to the TSB #0.

Then the TSB #0 turns off the move-in waiting flag, causes the TSB pointer calculation unit 17 to calculate a TSB pointer again, and causes the L1 data cache controller 7a to issue a TRF request again. Then, the L1 data cache controller 7a supplies the TRF request to the L1 cache control pipe line. Then the L1 data cache controller 7a determines that a cache hit is attained and outputs a signal representing that data of the target of the TRF request has been stored in the L1 data cache 7c to the TSB #0. In this case, the TSB #0 issues the TRF request again and causes the L1 data cache 7c to supply data corresponding to the cache hit.

Here, the L1 data cache 7c and the request check unit 18 are connected to a bus having a width of eight bytes. The L1 data cache 7c transmits the TTE-Data section first, and thereafter, transmits the TTE-Tag section. The request check unit 18 receives the data transmitted from the L1 data cache 7c and determines whether the received data is the TTE of the target of the TRF request.

In this case, the request check unit 18 compares the RA of the TTE-Data section with the upper limit PA[46:13] and the lower limit PA[46:13] so as to determine whether the RA of the TTE-Data section is included in a predetermined address range. Meanwhile, the request check unit 18 determines whether a virtual address of the TTE-Tag section supplied from the L1 data cache 7c coincides with one of the virtual addresses stored in the TSB #0.

When the RA of the TTE-Data section is included in the predetermined address range and the VA of the TTE-Tag section coincides with one of the virtual addresses stored in the TSB #0, the TSB #0 calculates a physical address of the TTE to be registered in the TLB 5. Specifically, the TSB #0 adds the offset PA[46:13] to the RA of the TTE-Data section so as to obtain the physical address of the TTE to be registered in the TLB 5. Note that, when the TSB-Walk control register 16 includes a plurality of upper limit registers and a plurality of lower limit registers, the request check unit 18 determines whether the RA of the TTE-Data section is included in the predetermined address range using an upper limit register having the smallest number and a lower limit register having the smallest number.

Thereafter, the request check unit 18 notifies the TSBW controller 19 of a request for registration to the TLB 5 when an appropriate check result is obtained. On the other hand, when the appropriate check result is not obtained, the request check unit 18 transmits a trap factor to the TSBW controller 19 as a result of the table walk relative to the TSB #0. In this case, the TSB #0 turns the trap detection flag off. Note that, when the TTE-Tag transmitted from the L1 data cache 7c does not coincide with one of the virtual addresses stored in the TSB #0, when the RA is not included in the predetermined address range, or when a path error occurs, the appropriate check result is not obtained.

As described above, the request check unit 18 executes a larger number of check processes on the TTE-Data section compared with the TTE-Tag section. Therefore, the HWTW 10 causes the L1 data cache 7c to output the TTE-Data section first so that an entire check cycle is shortened and the table walk process is performed at high speed.

When receiving the registration request from the request check unit 18, the TSBW controller 19 issues a request for registering the TTE to the TLB controller 5a. In this case, the TLB controller 5a registers the TTE including the TTE-Tag section checked by the request check unit 18 and the TTE-Data including the physical address calculated by the request check unit 18 in the TLB 5.

Furthermore, the TSBW controller 19 supplies a request corresponding to a TLB miss to the TLB 5 again so as to searches for the TTE registered in the TLB 5. As a result, the TLB 5 translates the virtual address into the physical address using the hit TTE and outputs the physical address obtained by the translation. Then, as with the case of a normal data obtaining request, the L1 data cache controller 7a outputs an operand or an instruction stored in a storage region specified by the physical address output from the TLB 5 to the calculation unit 4.

On the other hand, when receiving the notification representing the trap factor by the result of the table walk, the TSBW controller 19 performs the following process. Specifically, the TSBW controller 19 waits until a check result of a TTE obtained as a result of a TRF request of another TSB included in the request controller 12 is transmitted from the request check unit 18.

When receiving a registration request as the check result of a TTE obtained in response to a TRF request issued by one of the TSBs included in the request controller 12, the TSBW controller 19 issues a request for registering the TTE to the TLB controller 5a. Then, the TSBW controller 19 terminates the process.

Specifically, when the TTE of the request target is obtained by one of the TSBs #0 to #3, the TSBW controller 19 immediately issues a request for registering the TTE to the TLB controller 5a. Even when a trap factor is included in a result of the TRF request by the other TSB, the TSBW controller 19 ignores the trap factor and completes the process.

Furthermore, when completing the process, the TSBW controller 19 transmits a completion signal to the MIB of the L1 data cache 7c. The MIB turns the TRF request completion flag on when the TRF request flag is in an on state and when receiving the completion signal. In this case, even when the L2 cache 6 transmits data, the L1 data cache 7c does not transmit an activation signal to the TSBW controller 19 but only caches the data transmitted from the L2 cache 6.

When all check results of TTEs obtained in accordance with TRF requests issued by all TSBs included in the preceding request controller 14 represent notifications of trap factors, the TSBW controller 19 executes the following process. Specifically, the TSBW controller 19 notifies the L1 data cache controller 7a of a trap factor which has the highest priority and which relates to a TRF request issued by a TSB corresponding to the smallest number among the notified trap factors and causes the L1 data cache controller 7a to perform a trap process.

On the other hand, when all the check results regarding the TRF requests issued by all the TSBs #0 to #3 included in the preceding request controller 12 represent notifications of trap factors, the TSBW controller 19 immediately terminates the process. Furthermore, also in each of the other request controllers 12a and 12b, when all check results regarding TRF requests represent notifications of trap factors, the TSBW controller 19 immediately terminates a process.

Specifically, the TSBW controller 19 performs the trap process only when a trap factor regarding the TOQ is notified and terminates the process without performing the trap process when trap factors regarding other requests are notified. By this, also when TTE requests are subjected to an out-of-order execution, the TSBW controller 19 does not request change of logic of the L1 data cache 7c which performs a trap process only when a trap factor regarding the TOQ is detected. Consequently, the plurality of table fetch units 15, 15a, and 15b can be easily controlled.

As described above, the HWTW 10 performs table walk on TTEs regarding a plurality of operands as the out-of-order execution. Accordingly, the HWTW 10 can promptly obtain the TTEs regarding the plurality of operands. Furthermore, the HWTW 10 includes the plurality of table fetch units 15, 15a, and 15b which individually operate and assign different TTE requests to the different table fetch units 15, 15a, and 15b for individual strands (threads). Accordingly, the HWTW 10 can process the TTE requests regarding operands for individual strands (threads) as the out-of-order execution.

Note that, when a TTE is registered from the L1 data cache 7c to the TLB 5, the TLB controller 5a performs the registration by converting software executed by the CPU 1 into a data-in operation of newly registering a TTE to the TLB 5 in response to a storing instruction. Therefore, a circuit for executing an additional process is not requested to be implemented in the TLB controller 5a, and accordingly, the number of circuits can be reduced.

Note that, when a TRF request is aborted since a process of correcting a correctable one-bit error generated in an obtained TTE is executed, the L1 data cache controller 7a outputs a signal representing that the TRF request is aborted to the TSB #0. In this case, the TSB #0 issues a TRF request to the L1 data cache controller 7a again.

Furthermore, when a UE (Uncorrectable Error) is generated in data which is a target of a TRF request, the L1 data cache controller 7a outputs a signal representing that the UE is generated to the TSB #0. In this case, the L1 data cache controller 7a transmits a notification representing that an MMU-ERROR-TRAP factor is generated to the TSBW controller 19.

Furthermore, the L1 data cache controller 7a transmits the signals with a request port ID of the TRF request and a table walker ID, and therefore, the L1 data cache controller 7a can transmit the signals to an arbitrary TSB which has issued the TRF request.

For example, the instruction controller 3, the calculation unit 4, the L1 data cache controller 7a, and the L1 instruction cache controller 7d are electronic circuits. Furthermore, the TLB controller 5a and the TLB searching unit 5e are electronic circuits. Moreover, the request reception units 11, 11a, and 11b, the request controllers 12, 12a, and 12b, the preceding request reception unit 13, the preceding request controller 14, the TSB pointer calculation unit 17, the request check unit 18, and the TSBW controller 19 are electronic circuits. Here, examples of such an electronic circuit include an integrated circuit such as an ASIC (Application Specific Integrated Circuit) or an FPGA (Field Programmable Gate Array), a CPU (Central Processing Unit), and an MPU (Micro Processing Unit). The electronic circuits are constituted by a combination of logic circuitries, respectively.

Furthermore, the TLB main unit 5b, the context register 5c, the virtual address register 5d, the L1 data tag 7b, the L1 data cache 7c, the L1 instruction tag 7e, the L1 instruction cache 7f, and the TSB-Walk control register 16 are semiconductor memory elements such as registers.

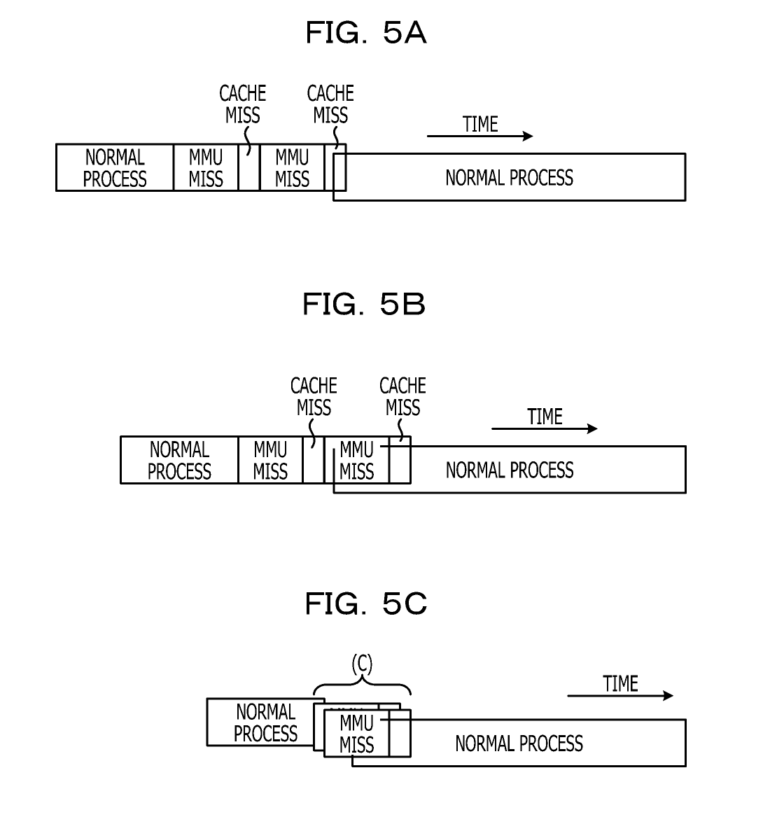

Next, referring to FIGS. 5A to 5C, a case where a period of time used for address translation is reduced even in a case where MMU misses consecutively occur when the HWTW 10 performs requests for obtaining TTEs regarding a plurality of operands included in the same strand (thread) will be described. FIG. 5A is a diagram illustrating a process of consecutively performing trap processes by the OS. FIG. 5B is a diagram illustrating a process of a Hard Ware Table Walk (HWTW) of a comparative example. FIG. 5C is a diagram illustrating a process of the Hard Ware Table Walk (HWTW) according to the embodiment.

Note that the term “normal process” described in FIGS. 5A to 5C represents a state in which an arithmetic processing unit performs arithmetic processing. Furthermore, the term “cache miss” described in FIGS. 5A to 5C represents a state in which a process of obtaining an operand from a main memory after a request for reading an operand included in a storage region specified by a physical address which has been subjected to the address translation results in a cache miss is being performed.

In the example illustrated in FIG. 5A, a CPU of the comparative example searches a TLB after a normal process and detects an MMU miss. Then the CPU of the comparative example causes the OS to perform a trap process so as to register a TTE in the TLB. Thereafter, the CPU of the comparative example performs address translation using the newly registered TTE and searches for data, and as a result, a cache miss occurs. Therefore, the CPU obtains an operand from the main memory.

Subsequently, the CPU of the comparative example searches the TLB and detects an MMU miss again. Therefore, the CPU causes the OS to perform a trap process again so as to register a TTE in the TLB. Thereafter, the CPU of the comparative example searches for data by performing address translation. However, since a cache miss occurs, the CPU obtains an operand from the main memory. In this way, the CPU of the comparative example causes the OS to perform a trap process every time an MMU miss occurs. Therefore, the CPU of the comparative example performs the normal process after the second MMU miss occurs and the TTE corresponding to the MMU miss is registered in the TLB.

Next, a process of executing the HWTW performed by the CPU of the comparative example will be described with reference to FIG. 5B. For example, when an MMU miss is detected, the CPU of the comparative example activates the HWTW and causes the HWTW to perform a process of registering a TTE. Then the CPU of the comparative example performs address translation using a cached TTE so as to obtain an operand. Next, although the CPU of the comparative example detects an MMU miss again, a normal process is started immediately after detection of the MMU miss since the CPU causes the HWTW to perform the process of registering a TTE. However, since the CPU of the comparative example causes the single HWTW to successively perform processes of registering a TTE every time an MMU miss occurs, the period of time used for arithmetic processing is only reduced by approximately 5%.

Next, referring to FIG. 5C, a process performed by the CPU 1 including the HWTW 10 will be described. When detecting a first MMU miss, the CPU 1 causes the HWTW 10 to perform a TTE registration process. Subsequently, the CPU 1 detects a second MMU miss. However, the HWTW 10 issues a request for newly obtaining a TTE even while the HWTW 10 is performing a TTE obtainment process. Then the HWTW 10 performs TTE obtainment requests regarding a plurality of operands in parallel as denoted by (C) of FIG. 5C. Therefore, even when MMU misses consecutively occur, the CPU 1 can promptly obtain TTEs resulting in reduction of a period of time used for arithmetic processing by approximately 20%.

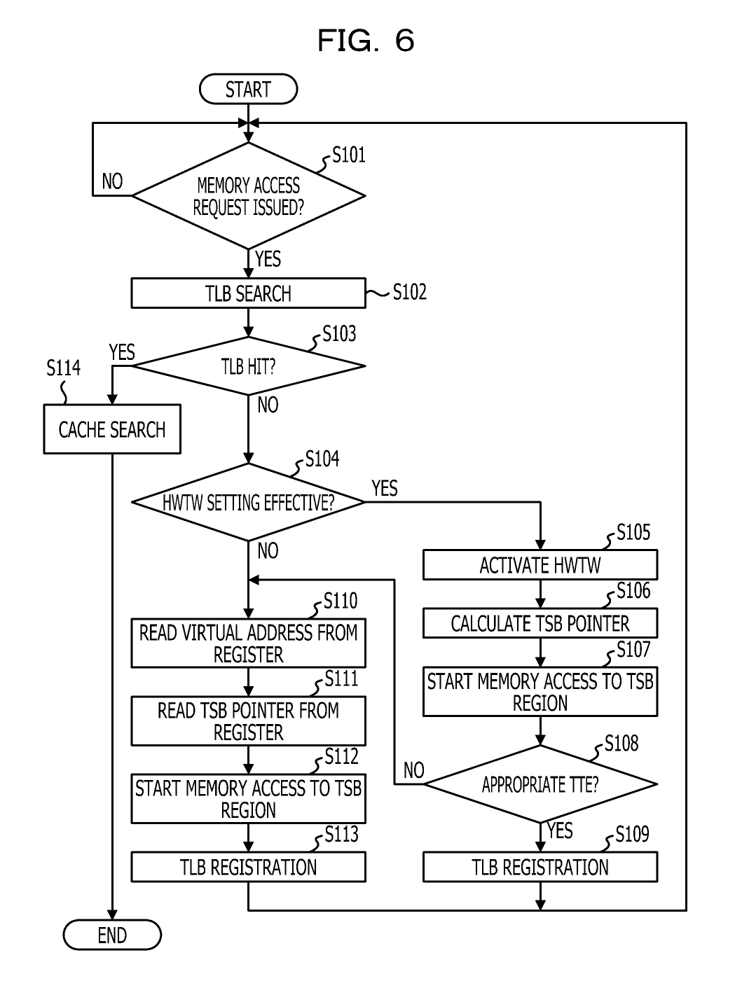

Next, a flow of a process executed by the CPU 1 will be described with reference to FIG. 6. FIG. 6 is a flowchart illustrating the process executed by the CPU 1 according to the embodiment. In the example illustrated in FIG. 6, the CPU 1 starts the process in response to an issuance of a memory access request as a trigger (step S101; Yes). Note that, when the memory access request is not issued (step S101; No), the CPU 1 does not starts the process and waits.

First, when the memory access request is issued (step S101; Yes), the CPU 1 searches the TLB for a TTE having a virtual address of a target of the memory access request which is to be translated into a physical address (in step S102). Thereafter, the CPU 1 determines whether a TLB hit of the TTE occurs (in step S103). Subsequently, when a TLB miss of the TTE occurs (step S103; No), the CPU 1 determines whether a setting representing whether table walk is to be performed using the HWTW 10 is effective (in step S104). Specifically, the CPU 1 determines whether a table walk significant bit representing whether the table walk is to be executed is in an on state.

When the CPU 1 intends to cause the HWTW 10 to perform the table walk (step S104; Yes), the CPU 1 activates the HWTW 10 (in step S105). Thereafter, the CPU 1 calculates a TSB pointer (in step S106) and accesses a TSB region of the memory 2 using the obtained TSB pointer so as to obtain a TTE (in step S107).

Next, the CPU 1 checks whether an appropriate TTE has been obtained (in step S108). When the appropriate TTE has been obtained, that is, a TTE of a target of a TRF request has been obtained (step S108; Yes), the CPU 1 registers the obtained TTE in the TLB 5 (in step S109).

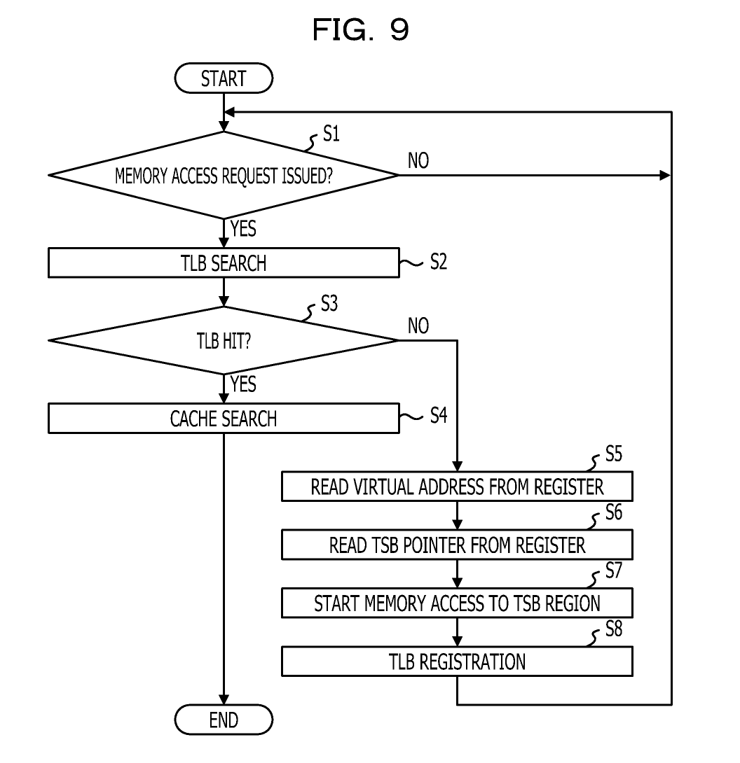

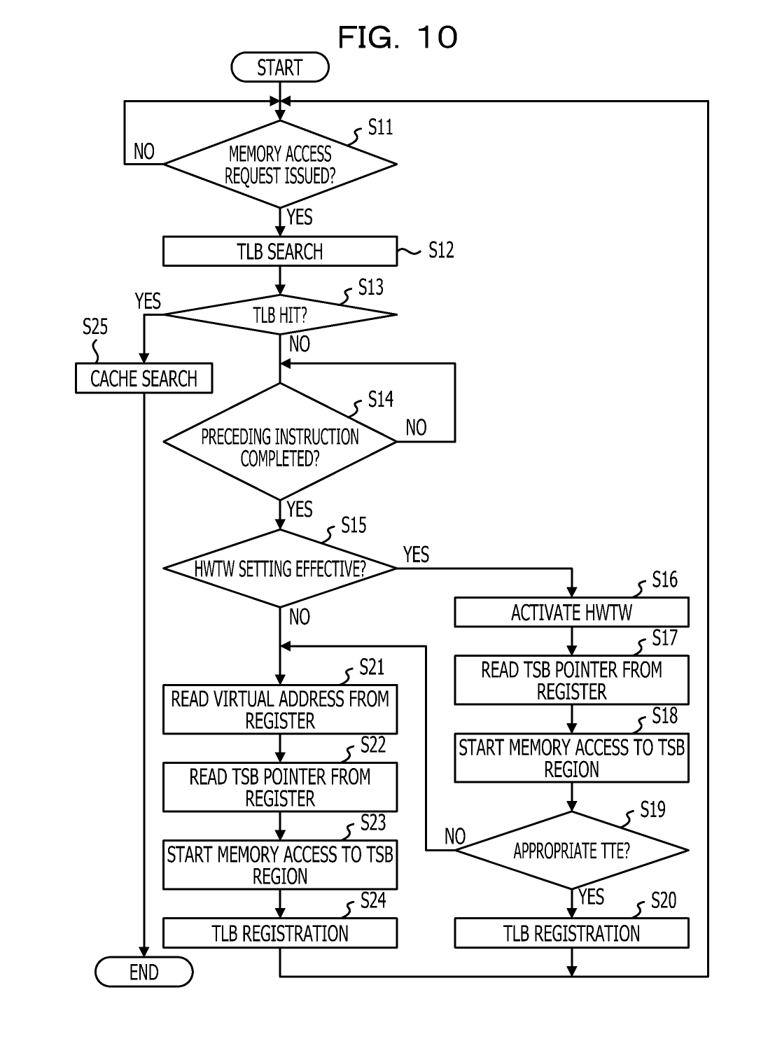

On the other hand, when an inappropriate TTE is obtained (step S108; No), the CPU 1 causes the OS to perform a trap process (in step S110 to step S113). Note that the trap process (from step S110 to step S113) performed by the OS is the same as a process (from step S5 to step S8 in FIG. 9) performed by the CPU of the comparative example, and a detailed description thereof is omitted.

Furthermore, when the TLB is searched for a TTE (in step S102) and a TLB hit occurs (step S103; Yes), the CPU 1 performs the following process.

Specifically, the CPU 1 searches the L1 data cache 7c for data of the target of the memory access request using a physical address obtained after address translation using the hit TTE (in step S114). Then the CPU 1 performs arithmetic processing the same as that performed in a normal state and terminates the process.

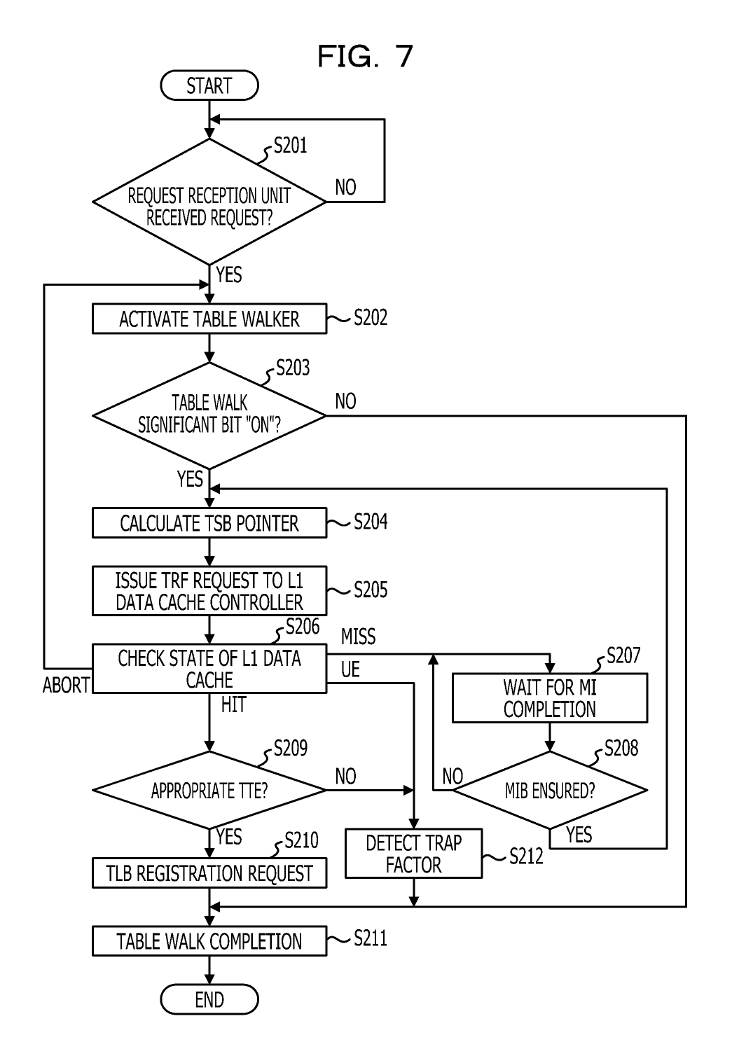

Next, a flow of a process performed by the Hard Ware Table Walk (HWTW) 10 will be described with reference to FIG. 7. FIG. 7 is a flowchart illustrating a process executed by the HWTW 10 according to the embodiment. In the example illustrated in FIG. 7, the HWTW 10 starts the process in response to receptions of requests by the request reception units 11, 11a, and 11b as triggers (step S201; Yes). Note that, when the request reception units 11, 11a, and 11b have not received requests (step S201; No), the HWTW 10 waits until a request is received.

First, the HWTW 10 activates TSBs #0 to #3 which are table walkers (in step S202). Subsequently, the HWTW 10 determines whether a table walk significant bit of the TSB configuration register is in an on state (in step S203). When the table walk significant bit is in the on state (step S203; Yes), the HWTW 10 calculates a TSB pointer (in step S204) and issues a TRF request to the L1 data cache controller 7a (in step S205).

Next, the HWTW 10 checks whether a TTE of a target the TRF request has been stored in the L1 data cache 7c in accordance with a response from the L1 data cache 7c (in step S206). When the TTE has not been stored in the L1 data cache 7c, that is, when a cache miss of the TTE occurs (step S206; MISS), the HWTW 10 enters a move-in (MI) waiting state of the TTE (in step S207).

Subsequently, the HWTW 10 determines whether a flag representing the TRF request has been stored in the MIB (in step S208). When the flag representing the TRF request has been stored in the MIB (step S208; Yes), the following process is performed. Specifically, the HWTW 10 calculates a TSB pointer again (in step S204) and issues a TRF request (in step S205). On the other hand, when the flag representing the TRF request has not been stored in the MIB (step S208; No), the HWTW 10 enters the move-in waiting state again (in step S207).

On the other hand, when the TRF request to the L1 data cache 7c is hit (step S206; HIT), the HWTW 10 determines whether a candidate of the hit TTE is an appropriate TTE (in step S209). When the TTE candidate is an appropriate TTE (step S209; Yes), the HWTW 10 issues a request for registering the obtained TTE to the TLB 5 (in step S210) and terminates the table walk (in step S211).

When the hit TTE candidate is not an appropriate TTE (step S209; No), the HWTW 10 detects a trap factor (in step S212), and thereafter, terminates the table walk (in step S211). Furthermore, when a UE occurs in data of the TTE stored in the L1 data cache 7c (step S206; UE), the HWTW 10 detects a trap factor (in step S212), and thereafter, terminates the table walk (in step S211).

Furthermore, when the TRF request is aborted (step S206; ABORT), the HWTW 10 activates the TSB #0 to #3 again (in step S202). Note that, when the table walk significant bit represents “off (0)” (step S203; No), the HWTW 10 does not perform the table walk and terminates the process (in step S211).

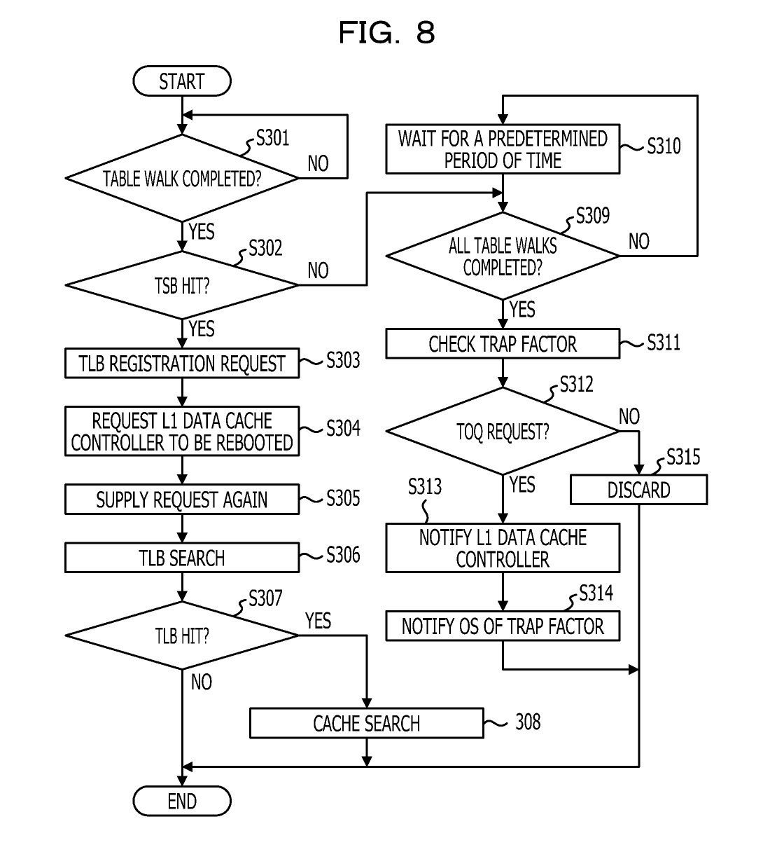

Next, a flow of a process performed by the TSBW controller 19 will be described with reference to FIG. 8. FIG. 8 is a flowchart illustrating the process performed by the TSBW controller 19 according to the embodiment. Note that, in the example illustrated in FIG. 8, the TSBW controller 19 starts the process in response to completion of the table walk of the TSBs #0 to #3 as a trigger (step S301; Yes). Furthermore, when the table walk of the TSBs #0 to #3 has not been completed (step S301; No), the TSBW controller 19 does not start the process and waits.

Subsequently, the TSBW controller 19 determines whether a TSB is hit by one of the TSBs #0 to #3 (in step S302). When a TSB is hit (step S302; Yes), the TSBW controller 19 issues a TLB registration request to the TLB controller 5a (in step S303). Next, the TSBW controller 19 requests the L1 data cache controller 7a to be rebooted (in step S304). Next, the TSBW controller 19 issues a TRF request again (in step S305) so as to searches the TLB 5 again (in step S306).

Thereafter, the TSBW controller 19 determines whether a TLB hit occurs (in step S307). When the TLB hit occurs (step S307; Yes), the TSBW controller 19 performs cache searching on the L1 data cache 7c (in step S308), and thereafter, terminates the process. On the other hand, when a TLB miss occurs (step S307; No), the TSBW controller 19 does not perform anything and terminates the process.

When TSB misses occur in all the TSBs #0 to #3 (step S302; No), the TSBW controller 19 determines whether all the TSBs included in one of the single request controllers 12, 12a, and 12b have completed the table walk (in step S309). When at least one of the TSBs has not completed the table walk (step S309; No), the TSBW controller 19 performs the following process. Specifically, the TSBW controller 19 waits for a predetermined period of time (in step S310) and determines whether all the TSBs included in one of the single request controllers 12, 12a, and 12b have completed the table walk again (in step S309).

On the other hand, when all the TSBs included in one of the single request controllers 12, 12a, and 12b have completed the table walk (step S309; Yes), the TSBW controller 19 checks the trap factor detected in step S212 of FIG. 7 (in step S311). Subsequently, the TSBW controller 19 determines whether the TRF request corresponding to the generated trap factor corresponds to a TOQ (in step S312).

When the TRF request corresponding to the generated trap factor has been stored in the TOQ (step S312; Yes), the TSBW controller 19 notifies the L1 data cache controller 7a of the trap factor (in step S313). Then the L1 data cache controller 7a notifies the OS of the trap factor (in step S314) and causes the OS to perform a trap process. Thereafter, the TSBW controller 19 terminates the process.

On the other hand, when the TRF request corresponding to the generated trap factor does not correspond to the TOQ (step S312; No), the TSBW controller 19 discards the trap factor (in step S315) and immediately terminates the process without perform anything.

### EFFECTS OF EMBODIMENT

As described above, the CPU 1 is connected to the memory 2 which stores a plurality of TTEs in which virtual addresses are translated into physical addresses. Furthermore, the CPU 1 includes the calculation unit 4 which executes a plurality of threads and which outputs a memory request including a virtual address. The CPU 1 includes the TLB 5 which registers some of the TTEs stored in the memory 2. When data to be subjected to arithmetic processing, that is, a TTE in which a virtual address where an operand is stored is translated into a physical address has not been registered in the TLB 5, the CPU 1 includes the TLB controller 5a which issues a TTE obtainment request to the HWTW 10.

Furthermore, the CPU 1 includes the plurality of table fetch units 15, 15a, and 15b each of which includes the plurality of request controllers 12, 12a, and 12b which obtain TTEs of targets of the issued obtainment requests from the memory 2. The TLB controller 5a issues different requests to the different table fetch units 15, 15a, and 15b for individual strands (threads) regarding TTE obtainment requests. The table fetch units 15, 15a, and 15b individually obtain TTEs. Moreover, the CPU 1 includes the TSBW controller 19 which registers one of the TTEs obtained by the table fetch units 15, 15a, and 15b in the TLB 5.

Therefore, even when memory accesses which lead MMU misses are consecutively performed, the CPU 1 can register a plurality of TTEs in which virtual addresses where operands are stored are translated into physical addresses in parallel. As a result, the CPU 1 can reduce a period of time used for the address translation.

Furthermore, even when a plurality of requests for obtaining TTEs regarding operands are issued in a single strand (thread), the CPU 1 can simultaneously register the TTEs, and accordingly, a period of time used for arithmetic processing can be reduced. Furthermore, even when requests for obtaining TTEs regarding operands are simultaneously issued in a plurality of strands (threads), the CPU 1 can simultaneously register the TTEs, and accordingly, a period of time used for the address translation can be reduced.

For example, as an example of a database system, a system employing a relational database method is generally used. In such a system, since information representing adjacent data is added to data, TLB misses (MMU misses) are likely to consecutively occur at a time of obtainment of data such as an operand. However, even when requests for TTEs regarding a plurality of operands consecutively result in TLB misses, the CPU 1 can simultaneously obtain the TTEs and perform the address translation. Accordingly, a period of time used for the arithmetic processing can be reduced. Furthermore, since the CPU 1 performs the process described above independently from the arithmetic processing, the period of time used for the arithmetic processing can be further reduced.

Moreover, the CPU 1 include the request controller 12 which obtains TTEs and which includes a plurality of TSBs #0 to #3 and causes the TSBs #0 to #3 to obtain TTEs from different regions. Specifically, the CPU 1 includes the plurality of TSBs #0 to #3 which calculate different physical addresses from a request for obtaining a single TTE and which obtain TTEs stored in the different physical addresses. Then the CPU 1 obtains a TTE, among the obtained TTE candidates, which includes a virtual address corresponding to the request by checking a TTE-Tag. Therefore, even when a plurality of regions to store TTEs are included in the memory 2, the CPU 1 can promptly obtain a TTE.

Furthermore, when a TTE obtainment request relates to an operand which is first issued in a certain strand (thread), that is, when the TTE obtainment request corresponds to a TOQ, the CPU 1 issues the TTE obtainment request to the preceding request reception unit 13. Then the CPU 1 causes the preceding request controller 14 to perform the request for obtaining the TTE corresponding to the TOQ and performs the TTE obtainment request stored in the TOQ. In this case, when a trap factor such as a UE is generated, the CPU 1 causes the OS to perform a trap process. Therefore, since the CPU 1 does not newly add a function to an L1 data cache controller of the comparative example which performs the trap process only on the TOQ, the HWTW 10 can be easily implemented.

Furthermore, the CPU 1 outputs a TSB pointer calculated using a virtual address to the L1 data cache controller 7a, causes the L1 data cache 7c to store a TTE, and registers the TTE stored in the L1 data cache 7c in the TLB 5. Specifically, the CPU 1 stores TTEs in the cache memory and registers one of the TTEs stored in the cache memory which corresponds to an obtainment request in the TLB 5. Therefore, since a function is not requested to be newly added to the L1 cache 7, the process of the HWTW 10 can be easily performed.

Furthermore, when it is determined whether an error has occurred in accordance with a TTE cached in the L1 data cache 7c or when it is determined whether a TTE relates to a request, the CPU 1 transmits the TTE-Data section first, and thereafter, transmits the TTE-Tag section. Therefore, since checking of the TTE-Data section which uses a long period of time can be started first, the CPU 1 can reduce a bus width between the L1 cache 7 and the HWTW 10 without increasing a period of time used for obtaining a TTE.

Although the embodiment of the present technique has been described hereinabove, the present technique may be embodied as various different embodiments other than the embodiment described above. Therefore, other embodiments included in the present technique will be described hereinafter.

(1) The Number of Table Fetch Units 15, 15a, and 15b

In the foregoing embodiment, the HWTW 10 includes the three table fetch units 15, 15a, and 15b. However, the present technique is not limited to this and the HWTW 10 may include an arbitrary number of table fetch units equal to or larger than 2.

(2) The Numbers of Request Reception Units 11, 11a, and 11b and Request Controllers 12, 12a, and 12b

In the foregoing embodiment, the HWTW 10 includes the three request reception units 11, 11a, and 11b and the three request controllers 12, 12a, and 12b. However, the present technique is not limited to this and the HWTW 10 may include an arbitrary number of request reception units and an arbitrary number of request controllers.

Furthermore, although each of the request controllers 12, 12a, and 12b and the preceding request controller 14 includes the plurality of TSBs #0 to #3, the present technique is not limited to this. Specifically, when a region which stores a TTE in the memory 2 is fixed, each of the request controllers 12, 12a, and 12b and the preceding request controller 14 may include a single TSB. Furthermore, when four candidates of a region which stores a TTE in the memory 2 exist, each of the request controllers 12, 12a, and 12b and the preceding request controller 14 may have the two TSBs #0 and #1 and table walk may be performed twice on each of the TSBs #0 and #1.

(3) Preceding Request Controller 14

The CPU 1 described above causes the preceding request controller 14 to perform a request for obtaining a TTE regarding the TOQ. However, the present technique is not limited to this. For example, the CPU 1 may include four request reception units 11, 11a, 11b, and 11c which have the same function and four request controllers 12, 12a, 12b, and 12c which have the same function. Then the CPU 1 causes a request controller 14 which issues the request for obtaining a TTE regarding the TOQ to have a TOQ flag. In this case, the TSBW controller 19 causes the OS to perform a trap process only when a trap factor is detected from a result of execution of the TRF request performed by the request controller having the TOQ flag.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing device comprising:
an arithmetic processing unit configured to execute a plurality of threads and output a memory request including a virtual address;
a buffer configured to register some of a plurality of address translation pairs stored in a memory, each of the address translation pairs including a virtual address and a physical address;
a controller configured to issue requests for obtaining the corresponding address translation pairs to the memory for individual threads when an address translation pair corresponding to the virtual address included in the memory request output from the arithmetic processing unit is not registered in the buffer;
a plurality of table fetch units configured to obtain the corresponding address translation pairs from the memory for individual threads when the requests for obtaining the corresponding address translation pairs are issued; and
a registration controller configured to register one of the obtained address translation pairs in the buffer.

2. The arithmetic processing device according to claim 1, wherein
the plurality of table fetch units calculate different physical addresses from virtual addresses corresponding to the different obtainment requests, and
the registration controller registers, among the plurality of address translation pairs stored in the obtained physical addresses, address translation pairs including the virtual addresses corresponding to the obtainment requests in the buffer.

3. The arithmetic processing device according to claim 1, wherein
the controller issues the obtainment request to a predetermined one of the table fetch units when one of the obtainment requests is output from the first one of the threads executed by the arithmetic processing unit, and
the predetermined table fetch unit causes an operating system executed by the arithmetic processing device to perform a trap process when an address translation pair obtained from the memory has an uncorrectable error.

4. The arithmetic processing device according to claim 1, wherein
the plurality of table fetch units calculate different physical addresses from virtual addresses corresponding to the different obtainment requests and store the obtained physical addresses in a cache memory, and
the registration controller registers, among the plurality of address translation pairs stored in the cache memory, address translation pairs including virtual addresses corresponding to the obtainment requests in the buffer.

5. The arithmetic processing device according to claim 4, wherein
the table fetch units obtain, when an error occurs in one of the address translation pairs stored in the cache memory, a physical address of the address translation pair including the error and thereafter obtain a virtual address of the address translation pair including the error.

6. The arithmetic processing device according to claim 3, wherein
the issuance unit issues, when an address translation pair corresponding to the virtual address included in the obtainment request output from the arithmetic processing unit is not registered in the buffer, the obtainment requests to table fetch units other then the predetermined table fetch unit.

7. A control method of controlling an arithmetic processing device including a buffer which registers some of a plurality of address translation pairs stored in a memory, the control method comprising:
executing a plurality of threads;
outputting a memory request including a virtual address;
issuing, when an address translation pair corresponding to the virtual address included in the memory request is not registered in the buffer, requests for obtaining the corresponding address translation pairs to the memory for individual threads;
obtaining, when the requests for obtaining the corresponding address translation pairs are issued, the corresponding address translation pairs from the memory by a plurality of table fetch units included in the arithmetic processing device for individual threads; and
registering one of the obtained address translation pairs in the buffer.

8. The control method according to claim 7, further comprising:
calculating different physical addresses from virtual addresses corresponding to the different obtainment requests,
wherein
the registering registers, among the plurality of address translation pairs stored in the obtained physical addresses, address translation pairs including the virtual addresses corresponding to the obtainment requests in the buffer.

9. The control method according to claim 7, wherein
the issuing issues, when one of the obtainment requests is output from the first one of the threads, the obtainment request to a predetermined one of the table fetch units, and
the control method includes
causing an operating system executed by the arithmetic processing device to perform a trap process when an address translation pair obtained from the memory has an uncorrectable error.

10. The control method according to claim 7, further comprising:
calculating different physical addresses from virtual addresses corresponding to the different obtainment requests; and
storing the obtained physical addresses in a cache memory,
wherein
the registering registers, among the plurality of address translation pairs stored in the cache memory, address translation pairs including virtual addresses corresponding to the obtainment requests in the buffer.

11. The control method according to claim 10, further comprising:
obtaining, when an error occurs in one of the address translation pairs stored in the cache memory, a physical address of the address translation pair including the error and thereafter obtaining a virtual address of the address translation pair including the error.

12. The control method according to claim 9, wherein
the issuing issues, when an address translation pair corresponding to the virtual address included in the output memory request is not registered in the buffer, the obtainment requests to table fetch units other then the predetermined table fetch unit.
